(19) United States
(12) Patent Application Publication
(10) Pub. No.: US 2004/0208597 A1
(43) Pub. Date: Oct. 21, 2004

(54) Free-Space optical transceiver link

(76) Inventors: John C. Wittenberger, Barrington, RI (US); Marshall C. Hudson, Northborough, MA (US)

Correspondence Address: TEXAS INSTRUMENTS INCORPORATED, P O BOX 655474, M/S 3999, DALLAS, TX, 75265

(21) Appl. No.: 10/208,238

(22) Filed: Jul. 30, 2002

(51) Int. Cl. H04B 10/00

(52) U.S. Cl. 398/130

(57) ABSTRACT

A wireless communication system for minimizing interference from physical limitations and the environment that includes at least a pair of optical links wherein each link includes a steered-beam transmitter assembly (T₁) and a steered-beam receiver assembly (R₂). The steered-beam transmitter assembly (T₁) couples a data signal to be transmitted and a first control signal at a first wavelength. The steered-beam transmitter assembly (T₁) includes a first micromirror assembly (26) for directing the transmitted data signal. The steered-beam receiver assembly (R₂) couples to receive the data signal having the first control signal coupled thereto and simultaneously generates and transmits a second control signal at a second wavelength. The steered-beam receiver assembly (R₂) includes a second micromirror assembly (26′) for directing the second control signal. The first and second control signals position the second and first micromirror assembly (26′, 26), respectively, such that the data signal is centered in the field of view of the steered-beam receiver assembly (R₂). Thus, the generated control signals effectively steer the data signal that is transmitted by the steered-beam transmitter assembly (T₁) and the data signal received by the steered-beam receiver assembly (R₂).

### CROSS-REFERENCE TO RELATED APPLICATION

The present invention relates to the copending applications entitled “Co-Aligned Receiver and Transmitter For Wireless Link,” Serial No. TBD (TI-32191), filed on Nov. 2, 2001, and “Free-Space Optical Transceiver Link,” Serial No. TBD (TI-33150), filed on Jan. 15, 2002, which are incorporated by reference herein.

### FIELD OF THE INVENTION

The present invention relates to optical communications, and, more particularly, to high speed optical wireless links.

### BACKGROUND OF THE INVENTION

Free-space optics enables fast deployment of broadband access services. A conventional free-space optical link includes two optical transceivers accurately aligned with each other given a clear field of view. Typically, each optical transceiver is mounted on a pole or on the roof or wall of a building. The optical transceiver includes a laser transmitter and receiver to provide full duplex capability. Adversely, atmospheric conditions have a significant impact on the optical link performance, causing severe problems in performance.

Specifically, weather conditions such as, fog, barometric pressure, and temperature may adversely affect the operation of the laser within the transmitter and between the field of view of the receiver and the transmitter. Thus, the availability of a free-space optical link is conventionally determined by the link length and fog patterns given a specific location.

In addition, a variety of physical limitations impedes the performance of an optical link. One such physical limitation is vibration since it produces both transitional and rotational movement of the receiver and the transmitter. If the vibrational rotation is larger than the transmitter beam divergence, or the receiver field of view, then the data flow between the transmitter and receiver will be lost. Thus, power cannot be sent from the transmitter to the receiver nor can the receiver collect power from the transmitter.

A traditional solution is to make the free space optical link sturdy while being fixed to the building, pole or wall. This solution, however, leads to the pole, wall, or building being the primary source of vibration which cannot be simply controlled.

Another approach increases the divergence beam size of the transmitter so that the divergence is larger than the rotational vibration. Given a fixed power, however, the beam intensity is inversely proportional to the divergence squared and, thereby, inversely proportional to the distance squared. Thus, if the divergence is doubled, the maximum working distance must be reduced to one half or the emitted beam power must be increased by a factor of four.

An alternative approach increases the field of view of the receiver such that the field of view is wider than the rotational vibration. The field of view is the angle across which a beam can be detected by the receiver. This is determined by the receiver's data detector radius and the data optics' focal length. Reducing the focal length of the data optics is not usually done as this also decreases the diameter of the data optics within the receiver and the amount of power that the data detector receives. Instead, the radius of the data detector is increased. Capacitance of the data detector, however, is proportional to its area or proportional to the radius squared. The response time of the data detector is inversely proportional to the capacitance. Thus, by increasing the field of view, the data rate of the receiver is limited.

Furthermore, increasing the field of view of the receiver increases the sensitivity of the receiver to all sources of light within its field of view which includes sunlight, artificial lighting or another transmitter. As a result, the bit error rate may increase.

Thus, a need exists for a device and system that transmits optical data while minimizing interference from physical limitations.

### SUMMARY OF THE INVENTION

To address the above-discussed deficiencies of wireless communication systems, the present invention teaches a system including at least a pair of free-space optical transceiver links wherein each link includes a steered-beam transmitter assembly and a steered-beam receiver assembly. The steered-beam transmitter assembly couples a first control signal at a first wavelength to a data signal to be transmitted. The steered-beam transmitter assembly includes a first micromirror assembly for directing the transmitted data signal. The steered-beam receiver assembly couples to receive the data signal having the first control signal coupled thereto. The steered-beam receiver assembly generates and transmits a second control signal at a second wavelength towards the steered-beam transmitter assembly. The steered-beam receiver assembly includes a second micromirror assembly for directing the second control signal. The first and second control signals position the second and first micromirror assembly, respectively, such that the data signal is centered in the field of view of the steered-beam receiver assembly. Thus, the generated control signals effectively steer the data signal that is transmitted by the steered-beam transmitter assembly and the data signal received by the steered-beam receiver assembly.

Advantages of this design include but are not limited to a system that transmits optical data while minimizing interference from physical limitations and the environment in that it gives the free-space optical transceiver link the ability to operate in extreme environmental temperatures. This design increases the optical wireless range. Ultimately, the control signals, independent from the data signals, act as pilot signals which position and align the data signals to be transmitted for efficient communication.

### BRIEF DESCRIPTION OF THE DRAWINGS

For a more complete understanding of the present invention and the advantages thereof, reference is now made to the following description taken in conjunction with the accompanying drawings in which like reference numbers indicate like features and wherein:

FIG. 1 is a wireless communication system in accordance with the present invention;

FIG. 2 displays a transceiver in accordance with the present invention;

FIG. 3 illustrates a known quad-cell servo detector;

FIG. 4 shows a quad-cell servo detector in accordance with an embodiment of the present invention; and

FIG. 5 displays a quint-cell servo detector in accordance with an embodiment of the present invention.

### DETAILED DESCRIPTION OF PREFERRED EMBODIMENTS

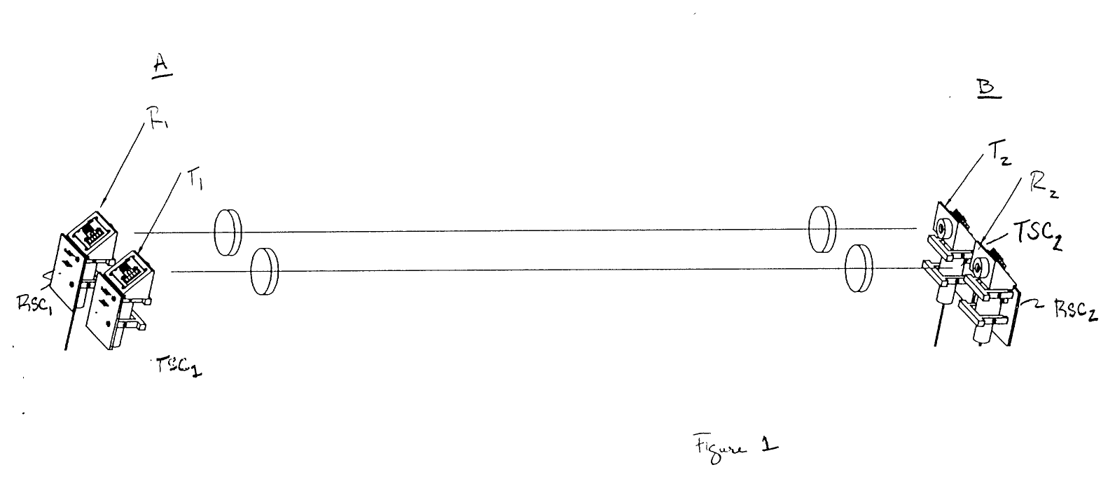

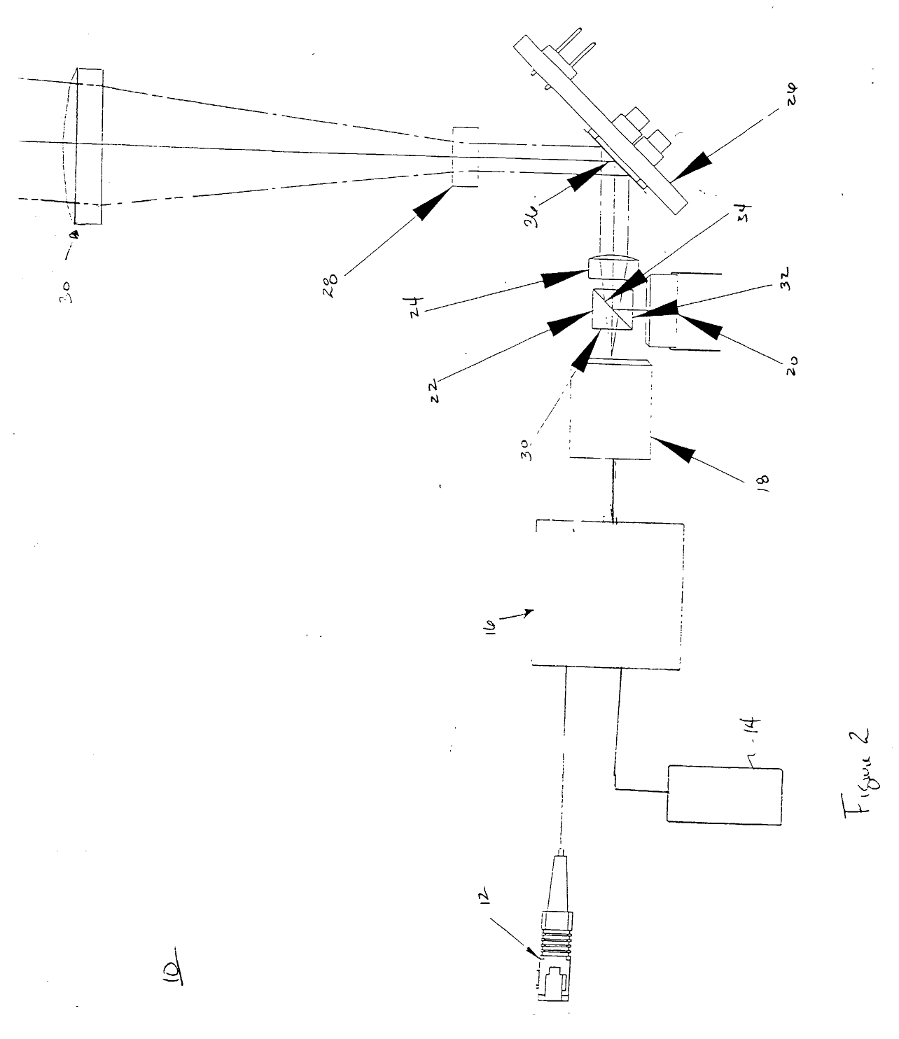

As illustrated in FIG. 1, a wireless communication system includes at least one free-space optical transceiver link including steered-beam transmitter assembly T₁ and steered-beam receiver assembly R₁ at a first location A within a network establishing communications with another free-space optical transceiver link including steered-beam transmitter assembly T₂ and steered-beam receiver assembly R₂ at a second location B within the network. Each transmitter and receiver assembly includes a control emitter for generating a control signal and a micromirror assembly having a micromirror, both of which are shown in FIG. 2. In addition, each free-space optical transceiver link further includes receiver system controllers, RSC₁, and RSC₂, and transmitter system controllers, TSC, and TSC₂. Each system controller RSC₁, RSC₂, TSC₁, and TSC₂ includes a servo detector circuit and couples to control the respective micromirror assembly and the control emitter. In the alternative, system controllers TSC₁ and RSC₁ may be combined, as well as system controllers TSC₂ and RSC₂ may be combined.

The process of communication between transmitter assembly T₁ and receiver assembly R₂ and between transmitter assembly T₂ and receiver assembly R₁ is the same. Thus, for simplicity, transmission of data between transmitter assembly T₁ and receiver assembly R₂ are explained as follows. With reference to FIG. 1, when transmitter assembly T₁ transmits a data signal having a first control signal having a first wavelength λ₁ coupled thereto to receiver assembly R₂, receiver assembly R₂ simultaneously sends a second control signal having a second wavelength λ₂ to transmitter assembly T₁. Transmitter assembly T₁ servo locks onto the second control beam sent by receiver assembly R₂ while receiver R₂ servo locks onto the first control beam sent by transmitter assembly T₁.

As receiver assembly R₂ translates, transmitter assembly T₁ rotates its mirror to maintain its servo lock on the second control beam sent by receiver assembly R₂. Similarly, as transmitter assembly T₁ translates, receiver assembly R₂ rotates its mirror to maintain its servo lock on the control beam of transmitter assembly T₁. Thus, if the structure on which transmitter assembly T₁ is mounted vibrates or deflects, causing transmitter assembly T₁ to move in translation or in rotation, then the micromirror assembly of transmitter assembly T₁ will, in response to the transmitter system controller, rotate its micromirror to maintain servo lock onto the second control beam. Similarly if the structure on which receiver assembly R₂ is mounted vibrates or deflects, causing receiver assembly R₂ to move in translation or in rotation, then the micromirror assembly within receiver assembly R₂ will, in response to the receiver system controller, rotate mirror to maintain servo lock onto the first control beam sent by transmitter assembly T₁. Thereby, the vibration problem is solved.

The receiver system controller RSC₂ in receiver assembly R₂ measures the average power in the first control beam sent by transmitter assembly T₁ and sends this information back to transmitter assembly T₁ by encoding it onto the second control beam sent by receiver assembly R₂. Transmitter assembly T₁ can adjust the power of the first control beam using the information obtained from receiver assembly R₂. The transmitter system controller TSC₁ of transmitter assembly T₁ measures the average power in the second control beam of receiver assembly R₂ and sends this information back to receiver assembly R₂ by encoding it into the first control beam which is sent by transmitter assembly T₁. Thus, receiver assembly R₂ is enabled to adjust the power of its control beam using this information.

Thereby, the transceiver in accordance with the present invention provides compensation for the distance that the transmitter assembly is located from the receiver and for bad weather conditions such as fog, rain, snow, etc. As an added feature, the receiver system controller RSC₂ of the receiver assembly R₂ keeps its power constant or within a working range which reduces the dynamic range requirement. The receiver system controller RSC₂ has a dynamic range of 30 dB without automatic gain control and the sources can be designed for a dynamic range of 30 dB. Thus, the system dynamic range can be 60 dB (1,000,000:1). As a result, automatic gain control on the receiver system controller RSC₂ can increase this dynamic range.

Specifically, transmitter assembly T₁ communicates its status and data to its transmitter system controller TSC₁ which includes the data beam source and the servo detector circuit 20. Using an interface such as standard cables RS232 or USB, the status and data is transferred to the transmitter system controller TSC₁ where transmitter assembly T₁'s power and data modulation rate is determined. TSC₁ is supplied the signal level of the first control beam measured by receiver system controller RSC₂ of receiver assembly R₂. TSC₁, responsive to the second control beam sent by receiver assembly R₂, adjusts the intensity of the data beam to compensate for the distance that transmitter assembly T₁ is from receiver assembly R₂ and for poor weather conditions.

The deflection of the first control signal due to thermal gradients in the atmosphere or scintillation appears to receiver assembly R₂ as though transmitter assembly T₁ is vibrating. The transceiver in accordance with the present invention, however, substantially reduces the effect of scintillation due to the mutual servo locking of receiver assembly R₂ and transmitter assembly T₁ and receiver assembly R₁ to transmitter assembly T₂ if the control loop bandwidth is sufficiently larger than the range from 200 to 400 Hertz.

FIG. 2 displays the transceiver 10 in accordance with the present invention. In a first mode, transceiver 10 operates as a transmitter assembly wherein a data signal is received by the fiber optics connector cable 12 and is coupled by coupler 16 with the first control signal emitted from control emitter 14. The control signal wavelength may differ from the wavelength of the data signal. Several sources of energy may be used for control emitter 14. These may include a discrete laser such as a vertical cavity surface emitting laser (VCSEL) or a Fabry Perrot laser, a discrete light emitting diode (LED), a single mode fiber optic with or without wave-division multiplexing (WDM), or a multimode fiber optic with or without WDM. Cable 12 connects to user equipment (not shown) where transmission wavelength, the number of transmission wavelengths and optical power may be selected.

Ferrule 18 spreads out the beam and directs the beam towards beam splitter 22. Beam splitter 22 includes a first and second coating surface 30 and 32 juxtapose to dichoic mirror 34. The first coating 30 is applied to enable beam splitter 22 to pass the data signal and the first control signal to be sent but redirects the second control signal coming from receiver assembly R₂ towards servo detector 20. This first coating 30 blocks stray signals that may effect the performance of the control emitter 14 or detector 20. The second coating 32 applied to beam splitter 22 to enable beam splitter 22 to pass the data signal and the first control signal but reflects the second control signal. Thereby, this second coating 32 blocks stray outgoing signals that may effect the performance of servo detector circuit 20. The silicon servo detector circuit 20 is not sensitive when the data signal is at wavelengths greater than 1100 nm.

In operation, when the beam enters through the first coating surface 30, it is directed towards the dichroic mirror 34 which severs the beam into two. The first beam is directed towards servo detector circuit 20 for collecting data on the second control signal's strength from the receiver assembly R₂. Simultaneously, the second beam is directed towards collimator lens 24 which collimates the data signal having the first control signal coupled thereto directing the signal towards a micromirror assembly 26. Micromirror assembly 26 includes a micromirror 36 that redirects and steers the collimated beam towards a beam expander lenses 28, 30.

Beam expander 28 and 30 may be implemented using a Galilean telescope wherein the first lens 28 is a negative lens and the second lens 30 is a positive lens. In the alternative, beam expander 28 and 30 may be implemented using a Kepler telescope wherein the first and second lens, 28 and 30, are both positive lenses. The implementation of both lenses 28 and 30 expands the beam and allows the user to transmit higher optical power while remaining safe for the eye. The larger beam can have reduced divergence. Both the higher power and reduced divergence allow the user to transmit the signal over longer distances. In the same proportion that the beam diameter is expanded, the total beam deflection is reduced for the same micromirror deflection.

In a second mode, transceiver 10 operates as receiver assembly R₂ wherein the data signal is received by beam reducer 30′ and 28′ which may be a Galilean or Kepler telescope. Beam reducer 30′ and 28′ directs the contracted beam towards micromirror 36′ contained in micromirror assembly 26′. Micromirror 36′ redirects the beam towards focusing lens 24′. The collimated beam is sent towards beam splitter 22′. Beam splitter 22′ includes a first and second coating surface 30′ and 32′. The first coating 30′ is applied to enable beam splitter 22′ to pass the data signal and the second control signal to be sent to the transmitter assembly T₁ but redirects the first control signal coming from transmitter assembly T₁ towards servo detector 20′. This first coating 30′ may also block stray signals that will effect the performance of the control emitter 14′ or detector 20′. The second coating 32′ applied to beam splitter 22′ to enable beam splitter 22 to pass the data signal and the second control signal being sent to transmitter assembly T₁ but redirects the first control, signal from transmitter assembly T₁ towards servo detector circuit 20′. Thereby, this second coating 32′ blocks stray outgoing signals that may effect the performance of servo detector circuit 20′. The silicon servo detector circuit 20′ is not sensitive when the data signal is at wavelengths greater than 1100 nm.

In summary, beam splitter 22′ splits an incoming beam into two beams: a first beam having the first control beam and a second beam having the data signal. The beam containing the first control beam is redirected towards servo detector circuit 20′, while the beam including the data signal is sent to the network through ferrule 18′ to beam coupler 16′. Ultimately, RSC₂ captures the signal from the four quadrants of servo detector circuit 20′ and sums the signals strength, while the second beam continues to traverse through ferrule 18′ towards the network through beam splitter 16′ as described above. Beam coupler 16′ transmits the second control signal from control emitter 14′ through ferrule 18′. Coupler 16′ may be implemented using a fiber optics splitter.

In reference to FIGS. 1 and 2, in operation, to obtain any signal from transmitter assembly T₁, receiver assembly R₂ must have its axis or center of field of view directly aimed at transmitter assembly T₁. Thus, the first micromirror 36 of transmitter assembly T₁ remains stationary while the second micromirror 36′ of receiver assembly R₂ adjusts such that the incoming control signal is centered on the second servo detector circuit 20′ of receiver assembly R₂. Once the second micromirror 36′ of receiver assembly R₂ adjusts, the second micromirror 36′ of receiver assembly R₂ remains stationary and the first micromirror 36 of transmitter assembly T₁ adjusts a small distance in one direction. When receiver assembly R₁ receives the signal strength information of the first control signal of transmitter assembly T₁, receiver assembly R₁ passes this information to transmitter assembly T₁. Specifically, second servo detector circuit 20′ of receiver assembly R₂ determines if the signal strength is increased or decreased and passes this information to transmitter assembly T₁. At this point, transmitter assembly T₁ assesses whether the micromirror of transmitter assembly T₁ was moved in the correct direction to maximize the received signal strength of the first control beam. Using this process, transmitter assembly T₁ optimizes its aim of the first control beam by adjusting its micromirror 36 in two angular directions. This process in repeated until the received signal strength is maximized. The same operation occurs between transmitter assembly T₂ and receiver assembly R₁.

As shown in FIG. 3, a conventional quad cell detector used for servo detector circuit 20 includes four quadrants. The control beam is focused at the center of the four detectors and the photo-current in all detectors is equal. If the focused spot moves to one quadrant, the photo-currents are no longer balanced and the resulting error signal is used in the servo loop to move the spot back to center. The equation used to analyze the error in the x-axis and y-axis are as follows:

X-error=[(B+C)−(A+D)]/[A+B+C+D] and

Y-error=[(A+B)−(C+D)]/[A+B+C+D].

These detectors have a large field of view. Accordingly, the servo performance could be compromised by the imaging of a second transmitter assembly that is located close to the transmitter assembly that is servo locked onto the receiver assembly. This large field of view allows for larger steps during the search mode and thus reduces the search time.

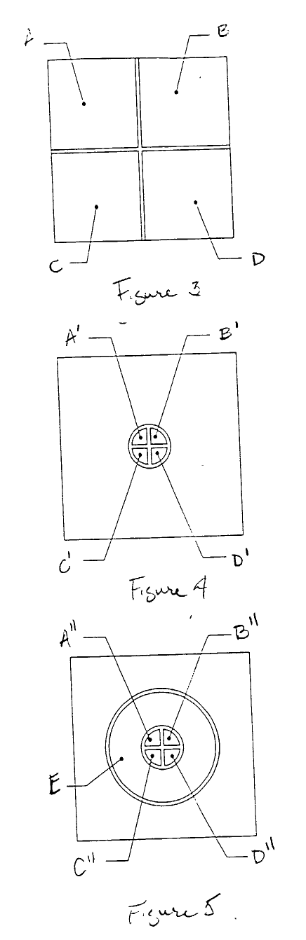

Therefore, an enhanced detector as shown in FIG. 4 may be implemented which includes a four quad detector whose diameter is the size of a focused control beam. As shown servo detector circuit 20 can be sized to be approximately equivalent to the image dimension that is formed on the servo circuit 20 by the control beam. Thereby, the amount of energy collected on the servo circuit 20 is proportional to the quality of focus and the maximum collected energy is the optimization of focus. This detector can thus be used to focus lens 24. The small size of detectors enables closely spaced transmitters not to compromise servo performance. Yet the smaller size equates to a longer search time than the conventional detector.

An alternate embodiment of servo detector 20 may include a servo detector having five cells as shown in FIG. 5, where the fifth detector surrounds a smaller set of quad detectors whose diameter is the size of a focused control beam. This detector, used in the search mode, increases the field of view, and hence reduces the search time. During search mode, the change in lens focus along with the use of this detector, reduces search time further. In instances where the changing of the lens focus increases the spot size of the control beam of either transmitter assembly T₁ or receiver assembly R₂, the larger diameter of the fifth detector provides a larger field of view to capture the control beam.

Due to the imperfections in dichroic mirror 34, some of the first control signal may pass through mirror 34 to coating 30. To improve performance, in another embodiment, a bandpass filter (not shown) may be placed in the optical path of between ferrule 18 and beam splitter 22 such that only energy at the data signal's wavelength or the control beam's wavelength generated by control emitter 14 may be permitted to pass through ferrule 18. It may be implemented as a third coating (not shown) applied to the surface of the first surface coating 30. Thereby, all other wavelengths are prevented from entering into the fiber optics cable 12.

In a third embodiment, servo lock and communication are established by implementation of a search mode. In a search mode, the receiver system controller RSC₂ moves micromirror 26′ in steps that are the width of the first control beam of the transmitter assembly T₁, while transmitter system controller TSC, sweeps its control beam in raster or spiral manner by moving its micromirror 26, covering a range of area as determined by the range of motion of micromirror 26. The control beam sweeps in steps that are equal to the width of the control beam of receiver assembly R₂. To ensure that receiver assembly R₂ and transmitter assembly T₁ find each other, receiver assembly R₂ moves an additional step at the completion of each transmitter sweep. The width of the first control beam of transmitter assembly T₁ may be the same as the width of the second control beam of receiver assembly R₂.

Search time is decrease by increasing the divergence of the control beams. Defocusing both the transmitter assembly T₁ and receiver assembly R₂ to enlarge their control beam size and thus reduce the time to scan both ranges of coverage. When both the transmitter assembly T₁ and receiver assembly R₂ detect each other, focus can be improved and the search pattern restarted from the position of detection, over a smaller maximum range. In this manner, the focus and position can establish in a minimum amount of time.

In a fourth embodiment, collimating lens 24 is movable in order to defocus the control beams of transmitter assembly T₁ and receiver assembly R₂. Movable lens 24 may be implemented using, for example, a transducer or a piezzo electric crystal connected to lens 24 that moves lens 24 along the optical axis in manner to focus the lens 24. Thus, the focus of the control beams of the transmitter assembly T₁ and the receiver assembly R₂ are optimized. As the control beams are focused, the data beam is focused and, thereby, the receiver assembly R₂ is optimized to obtain maximum signal collection. In addition, focus can be maintained as the temperature changes even though the thermal expansion of the lens and mechanical structure of receiver assembly R₂ may defocus the beam. Thus, servo-lock is establish when transmitter assembly T₁ and receiver assembly R₂ first detect each other and thereafter to maintain servo-lock as the focus is slowly improved.

In a fifth embodiment, both the transmitter assembly T₁ and receiver assembly R₂ may include an alignment telescope to aid in the initial alignment during installation of the transceiver within a wireless communication network.

In a sixth embodiment, the control beams of transmitter assembly T₁ and receiver assembly R₂ may be modulated to improve the signal to noise ratio of the transmitter and receiver system controller, TSC, and RSC₂, wherein the modulation rate of the control beam of transmitter assembly T₁ may differ from the modulation rate of the control beam of receiver assembly R₂. Thereby, the transceiver in accordance with the present invention improves the signal to noise ratio in the servo circuitry and minimizes the cross talk between the incoming control beam and the outgoing control beam using frequency-tuned amplification.

In a seventh embodiment, the control beams of transmitter assembly, T₁ and T₂, and receiver, R₁ and R₂, may include an identification code to inform other transmitter and receivers and prevent them from servo-locking onto the wrong unit. Such is the case, where a transmitter is located close to another transmitter and both are searching for a receiver. The identification code will enable each transmitter to select the proper receiver. Similarly, two receivers may be located close to one another where they are instructed to find a transmitter. Each receiver will be successful in finding the correct transmitter using the identification number.

Advantages of this design include but are not limited to a system that transmits optical data while minimizing interference from physical limitations. The smaller transmitter beam divergence translates into a beam that is more concentrated on the receiver. This concentrated energy means the distance between the transmitter and the receiver can be increased and that there is a greater power margin that can overcome the effect of poor weather conditions. The smaller receiver's field of view translates to a receiver having less sensitivity to background light. This transceiver is a less expensive solution to scintillation. The automatic focusing feature enables the transceiver to overcome errors in achieving initial focus and those errors associated with maintaining focus. Automatic gain control in the receiver and controlling the power of the transmitted signal increases the dynamic range.

As an added advantage, having a small field of view for receiver assembly R₂ and focusing receiver assembly R₂ directly onto transmitter assembly T₁, receiver assembly R₂ is less sensitive to other background light such as the sun, artificial light or another transmitter assembly's beam.

Since the data and control beams have low divergence of about 0.2 milliradians as oppose to other solutions where divergence of the beams is from 2 to 4 milliradians, the signal loss problem due to fog or poor weather conditions is solved. Furthermore, since received power is proportional to the divergence squared, the system margin improves by 20 to 26 dB. The ability to monitor the received power and adjust the source power adds about 30 dB to produce a 50 to 56 dB additional system margin over conventional systems. Thereby, the life of the data source and the control beam sources are improved, since these sources are not required to operate at maximum power except in poor weather conditions.

The reader's attention is directed to all papers and documents which are filed concurrently with this specification and which are open to public inspection with this specification, and the contents of all such papers and documents are incorporated herein by reference.

All the features disclosed in this specification (including any accompany claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. An free-space optical transceiver link for communicating data within a wireless communication network, comprising:
a steered-beam transmitter assembly, having a first micromirror assembly including a field of view, the steered-beam transmitter assembly coupled to receive a data signal to be transmitted for coupling a first control signal at a first wavelength to the data signal, the first micromirror assembly for directing the transmitted data signal; and
a steered-beam receiver assembly, having a second micromirror assembly including a field of view, the steered-beam receiver assembly coupled to receive the data signal having the first control signal coupled thereto, the second micromirror assembly for directing a second control signal at a second wavelength towards the steered beam transmitter assembly, the steered-beam transmitter assembly coupled to receive the second control signal, the first and second control signals enabled to position the second and first micromirror assembly, respectively, such that the first and second control signals are centered in the field of view of the respective steered-beam receiver and transmitter assembly.

2. The free-space optical transceiver link as recited in claim 1, wherein the first and second control beams include an identification code for the respective steered-beam transmitter assembly and the steered-beam receiver assembly.

3. The free-space optical transceiver link as recited in claim 1, wherein the steered-beam transmitter assembly comprises:
an electromagnetic radiation source to generate the first control signal at the first wavelength, responsive to the first control signal;
a beam coupler coupled to receive the data signal and the first control signal to couple the data signal and the first control signal together;
a ferrule having a fiber coupled to receive the data signal having the first control signal coupled thereto to spread out the data signal;
a beam splitter coupled to receive the data signal to pass the data signal, the beam splitter coupled to receive the second control signal sent from the steered beam receiver assembly to deflect the second control signal;
a servo detector coupled to receive the deflected second control signal to measure the intensity of the second control signal corresponding to the center of view of the steered-beam transmitter assembly and to generate control information for the first control signal responsive to the intensity measurement;
a collimator lens coupled to receive the data signal to collimate the data signal;
the first micromirror assembly coupled to receive the collimated data signal and enabled to direct the collimated data signal towards the steered-beam receiver assembly, responsive to the second control signal to center the data signal on the center of view of the receiver assembly; and
a beam expander coupled to receive the collimated data signal to expand the diameter of the beam to be transmitted.

4. The steered-beam transmitter assembly as recited in claim 3, wherein the first micromirror assembly is enabled to deflect the collimated first beam in either an X and a Y axis.

5. The steered-beam transmitter assembly as recited in claim 3, wherein the beam expander is a Galilean telescope.

6. The steered-beam transmitter assembly as recited in claim 3, wherein the beam expander is a Kepler telescope.

7. The steered-beam transmitter assembly as recited in claim 3, wherein the data signal is highly collimated.

8. The steered-beam transmitter assembly as recited in claim 3, wherein the collimating lens is movable to enable the focusing and defocusing of the first control beam for searching for the steered-beam receiver assembly.

9. The steered-beam transmitter assembly as recited in claim 3, wherein the servo detector is a multicell detector to sense beam position.

10. The steered-beam transmitter assembly as recited in claim 3, wherein the servo detector is a four cell detector having a diameter substantially the size of the diameter of the first control signal image.

11. The steered-beam transmitter assembly as recited in claim 3, wherein the servo detector is a five cell detector, the first, second, third and fourth cells arranged together having a diameter substantially the size of the diameter of the first control signal image, the first, second, third and fourth cells surrounded by the fifth cell.

12. The steered-beam transmitter assembly as recited in claim 3, further comprising a modulator coupled to receive the data signal from the electromagnetic radiation source to modulate the data signal, wherein the beam coupler couples to receive the modulated data signal.

13. The steered-beam transmitter assembly as recited in claim 3, further comprising an alignment telescope to further assist with searching for the steered-beam receiver assembly.

14. The steered-beam transmitter assembly as recited in claim 3, further comprising a bandpass filter coupled to receive the data signal from the ferrule for filtering beams at the first wavelength.

15. The free-space optical transceiver link as recited in claim 1, wherein the steered-beam receiver assembly comprises:
a beam reducer coupled to receive the expanded data signal having the first control signal coupled thereto of the steered-beam transmitter assembly to contract the diameter of the expanded data signal;
the second micromirror assembly coupled to receive the contracted data signal and enabled to direct the data signal;
a focusing lens coupled to receive the data signal to collimate the signal;
a first beam splitter coupled to receive the data signal to separate the signal into a first beam including the data signal and a second beam including the first control signal;
a servo detector coupled to receive the second beam to measure the intensity of the first control signal corresponding to the center of view of the steered-beam receiver assembly for repositioning of the second micromirror assembly and to generate control information for the second control signal responsive to the intensity measurement for repositioning of the first micromirror assembly;
a second beam splitter coupled to receive the first beam to transmit to the network; and
an electromagnetic radiation source coupled to the second beam splitter to generate the second control signal at the second wavelength, responsive to the first control signal.

16. The steered-beam receiver assembly as recited in claim 15, wherein the second micromirror assembly is enabled to deflect the contracted beam in either an X and a Y axis.

17. The steered-beam receiver assembly as recited in claim 15, wherein the beam contractor is a Galilean telescope.

18. The steered-beam receiver assembly as recited in claim 15, wherein the beam contractor is a Kepler telescope.

19. The steered-beam receiver assembly as recited in claim 15, wherein the second control signal is highly collimated.

20. The steered-beam receiver assembly as recited in claim 15, wherein the collimating lens is movable to enable the focusing and defocusing of the second control beam for searching for the steered-beam receiver assembly.

21. The steered-beam receiver assembly as recited in claim 15, wherein the servo detector is a multicell detector to sense beam position.

22. The steered-beam receiver assembly as recited in claim 15, wherein the servo detector is a four cell detector having a diameter substantially the size of the diameter of the second control signal image.

23. The steered-beam receiver assembly as recited in claim 15, wherein the servo detector is a five cell detector, the first, second, third and fourth cells arranged together having a diameter substantially the size of the diameter of the second control signal image, the first, second, third and fourth cells surrounded by the fifth cell.

24. The steered-beam receiver assembly as recited in claim 15, further comprising a modulator coupled to receive the second control signal from the control emitter to modulate the second control signal, wherein the second beam splitter couples to receive the modulated second control signal.

25. The steered-beam receiver assembly as recited in claim 15, further comprising an alignment telescope to further assist with searching for the steered-beam transmitter assembly.

26. The steered-beam receiver assembly as recited in claim 15, further comprising a bandpass filter coupled to receive the data signal from the first beam splitter for filtering signals at the first wavelength.

27. A method of transmitting data in an optical wireless network, comprising:
coupling a first control signal at a first wavelength to a data signal at a first location within a steered-beam transmitter assembly having a first micromirror assembly and a first servo detector;
transmitting the data signal having the first control signal coupled thereto to a steered-beam receiver assembly having a second micromirror assembly and a second servo detector;
receiving the data signal having the first control signal coupled thereto from the steered-beam transmitter assembly;
splitting the data signal having the first control signal coupled thereto into a first beam having the data signal and a second beam having the first control signal;
reflecting the second beam onto the second servo detector to generate control information for the first control signal;
generating a second control signal using the control information of the second servo detector to reposition the second micromirror assembly;
transmitting the first beam to the network;
transmitting the second control signal to the steered beam transmitter assembly;
reflecting the second control signal to a first servo detector to generate control information for the second control signal; and
modifying the first control signal using the control information of the first servo detector to reposition the first micromirror assembly.
